(19) United States
(12) Patent Application Publication
(10) Pub. No.: US 2006/0195464 A1
(43) Pub. Date: Aug. 31, 2006

(54) Dynamic data delivery

(75) Inventor: Qing T. Guo, Palo Alto, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/068,566

(22) Filed: Feb. 28, 2005

(51) Int. Cl. G06F 17/00

(52) U.S. Cl. 707/101

(57) ABSTRACT

Dynamic data delivery is performed by a server system responsible for transmitting data over a network. The server automatically determines when to transmit the data and whether to compress the data. If the data is to be compressed, the server may also determine which of a plurality of compression algorithms to apply. Factors considered by the server system may include, but are not limited to: available network bandwidth, current bandwidth cost, expected processing time for compressed data compared to expected processing time for uncompressed data, client device characteristics, data loss resiliency, and/or expected degree of compression.

### TECHNICAL FIELD

This invention relates to data delivery, and more specifically, to dynamic data delivery.

### BACKGROUND

Many networks exist that are asymmetrical in that the server is a large, fast computer, while one or more client systems are fairly slow, small computers. One example of such a network is a television network (e.g., cable or IP) where data is transmitted from a large server system to one or more television set-top boxes, which, in comparison to the server, are very slow and small. Furthermore, such networks typically have varying usage rates depending, for example, on the time of day. At peak usage times, available bandwidth may be very limited.

In a television network, client devices typically have limited processing power and it is important to allow the most content to be delivered while minimizing client computational requirements. For example, due to bandwidth constraints, only a fixed amount of data can be sent over the network at any given time. If data to be transmitted over the network is first compressed, a larger amount of data can be sent to the client devices at any given time than if the data is sent uncompressed. Compression poses a problem in asymmetrical networks, however, in that the client devices may have limited processing capabilities, and may be unable to efficiently decompress the received data.

Accordingly, a need exists for a dynamic data delivery technique that determines when and how (e.g., compressed or not) to transmit data over a network based, for example, on available network bandwidth, current bandwidth cost, and/or client computational requirements.

### SUMMARY

Dynamic data delivery is described herein.

In an implementation of dynamic data delivery, a server system dynamically determines whether or not to compress data before transmitting it over a network based, at least in part, on available network bandwidth. Furthermore, the server system may dynamically select one of multiple compression algorithms based, for example, on a degree of compression that can be achieved.

In another implementation of dynamic data delivery, a compression algorithm is automatically selected based on a resiliency to loss associated with the data to be delivered. For example, data such as video streams, music files, or images may be resilient to loss, resulting in the selection of a lossy compression algorithm. On the other hand, an extensible markup language (XML) file, for example, may not be resilient to loss, resulting in the selection of a lossless compression algorithm.

In another implementation of dynamic data delivery, a server determines when to transmit the data and whether or not to compress the data based, at least in part on a current bandwidth cost.

In another implementation of dynamic data delivery, a server system dynamically determines whether or not to compress data and/or dynamically selects a particular compression algorithm based on an expected processing time for handling the data in an uncompressed format compared to an expected processing time for handling the data in a compressed format. Processing time for handling the data may include any combination of processing time for applying a compression algorithm, transmission time of the data over a network, and processing time for decompressing the data from a compressed format.

In another implementation of dynamic data delivery, a server system dynamically determines whether or not to compress data and/or dynamically selects a particular compression algorithm based on characteristics associated with a client device to which the data is to be transmitted. Such characteristics may include, but are not limited to, client device storage capacity and a time at which the client device is expected to use the data.

### BRIEF DESCRIPTION OF THE DRAWINGS

The same numbers are used throughout the drawings to reference like features and components.

FIG. 1 is a block diagram illustrating dynamic delivery of data over a network.

FIG. 2 is a pictorial diagram illustrating an exemplary network environment in which dynamic data delivery may be implemented.

FIG. 3 is a block diagram of selected components of an exemplary server configured to implement dynamic data delivery.

FIG. 4 is a block diagram of selected components of an exemplary client device configured to receive dynamically delivered data.

FIG. 5 is a flow diagram of an exemplary method for dynamic data delivery based on available network bandwidth.

FIG. 6 is a flow diagram of an exemplary method for dynamic data delivery based on current bandwidth cost.

FIG. 7 is a flow diagram of an exemplary method for dynamic data delivery based on expected processing time.

FIG. 8 is a flow diagram of an exemplary method for dynamic data delivery based on client storage capacity.

FIG. 9 is a flow diagram of an exemplary method for dynamic data delivery based on data type.

FIG. 10 is a flow diagram of an exemplary method for dynamic data delivery based on degree of compression.

### DETAILED DESCRIPTION

Many network systems experience more or less network traffic at different times, resulting in variance in available network bandwidth. Asymmetrical networks that include a large, fast server system and one or more smaller, slower client systems may be significantly impacted by variances in available network bandwidth. An IP-based television network is one example of an asymmetrical network in which available network bandwidth varies over time. For example, at 2:00 am, there is likely to be less network traffic, and thus more available bandwidth than at 9:00 pm. In such a system, dynamic data delivery can be implemented to allow the most data to be delivered while staying within the bounds of the available bandwidth and minimizing client computational requirements.

The following discussion is directed to dynamic data delivery. While features of dynamic data delivery can be implemented in any number of different computing environments, they are described in the context of the following exemplary implementations.

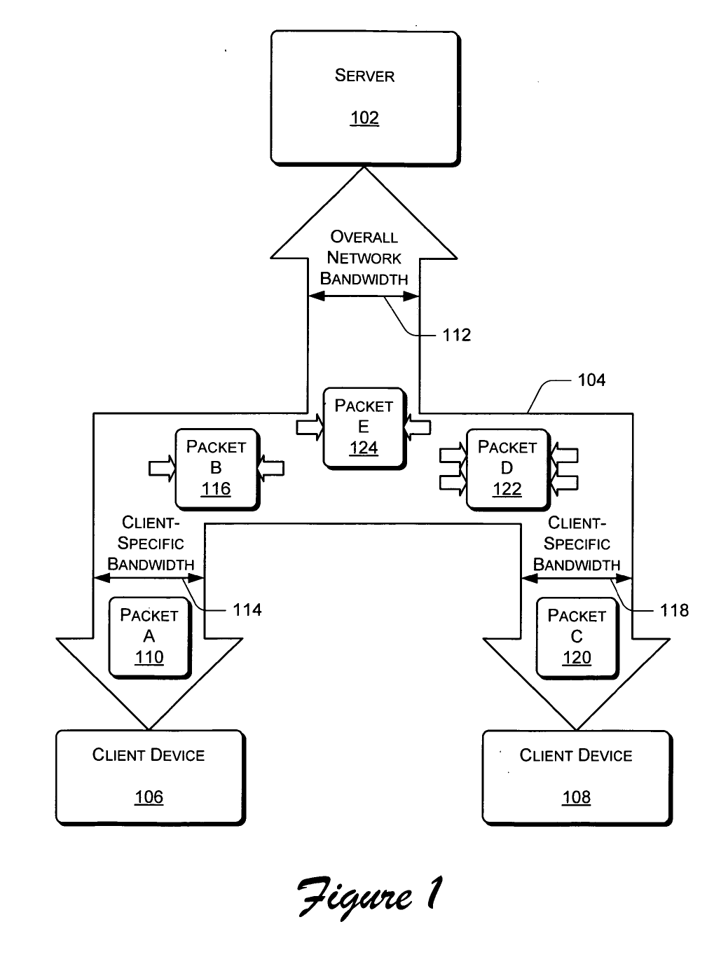

FIG. 1 illustrates transmission of dynamically compressed data packets over a network. In the illustrated example, server 102 transmits data packets over network 104 to client device 106 and to client device 108. Before transmitting a particular data packet, server 102 evaluates the currently available network bandwidth. If the network bandwidth is sufficiently unrestricted, then the data packet is sent in an uncompressed format. If the network bandwidth (i.e., either the overall network bandwidth available to the server, or the network bandwidth between the server and a particular client) is sufficiently restricted, then the data packet may be compressed before it is transmitted.

For example, before transmitting packet A 110 to client device 106, server 102 evaluates the available overall network bandwidth 112 and the client-specific network bandwidth 114. When server 102 determines that the available overall network bandwidth and the available client-specific network bandwidth is sufficient, packet A 110 is transmitted in an uncompressed format to client device 106.

Server 102 may then prepare to transmit packet B 116 to client device 106. Server 102 may determine that the available overall network bandwidth 112 is sufficient, but that the client-specific bandwidth 114 is not sufficient for transmitting packet B 116 in an uncompressed format (e.g., there may be a bottleneck between server 102 and client device 106 that is limiting the ability of client device 106 to receive data). Accordingly, packet B 116 is compressed (represented in FIG. 1 by the arrows pointing toward packet B 116) before it is transmitted to client device 106. Assuming overall network bandwidth 112 and client-specific bandwidth 118 are sufficient, packet C 120 is transmitted to client device 108 in an uncompressed format.

In an exemplary implementation, data packets may be compressed even if the available bandwidth is not restricted. For example, if the time it takes to transmit the packet in compressed form (T_{C}) and the time it takes for the client device to decompress the received packet (T_{D}) is less than the time it takes to transmit the uncompressed packet (T_{U}) (i.e., T_{C}+T_{D}<T_{U}), then the server may compress the data packet regardless of whether or not the available bandwidth is restricted. In another example, data sent to a particular client device may be compressed regardless of bandwidth availability if the client device has limited storage capacity. In such an implementation, the client device may receive and store compressed data, and then decompress the data as it is needed.

Furthermore, varying degrees of compression may be applied based on available bandwidth and/or time savings. For example, packet D 122 is compressed more (represented by the double arrows on either side of the packet) than packet E 124. Another factor that may be used to determine whether and how much a packet or file is compressed is the data type. For example, lossy compression schemes, which typically produce smaller compressed data, may be used for data types that are resilient to loss, such as images, music files, and video streams. Lossless compression schemes may be used for data that should be transmitted completely accurately in order to be used properly, such as simple object access protocol (SOAP) message, extensible markup language (XML) files, and most types of human readable text.

FIG. 1 illustrates an embodiment in which compression is applied at a packet level. Such compression is typically implemented at a network protocol level in the software stack of server 102. Other embodiments are also considered, such as applying the compression at a file level or in the case of SOAP at a message level. Such compression is typically implemented at a file-system level in a layered software system of server 102.

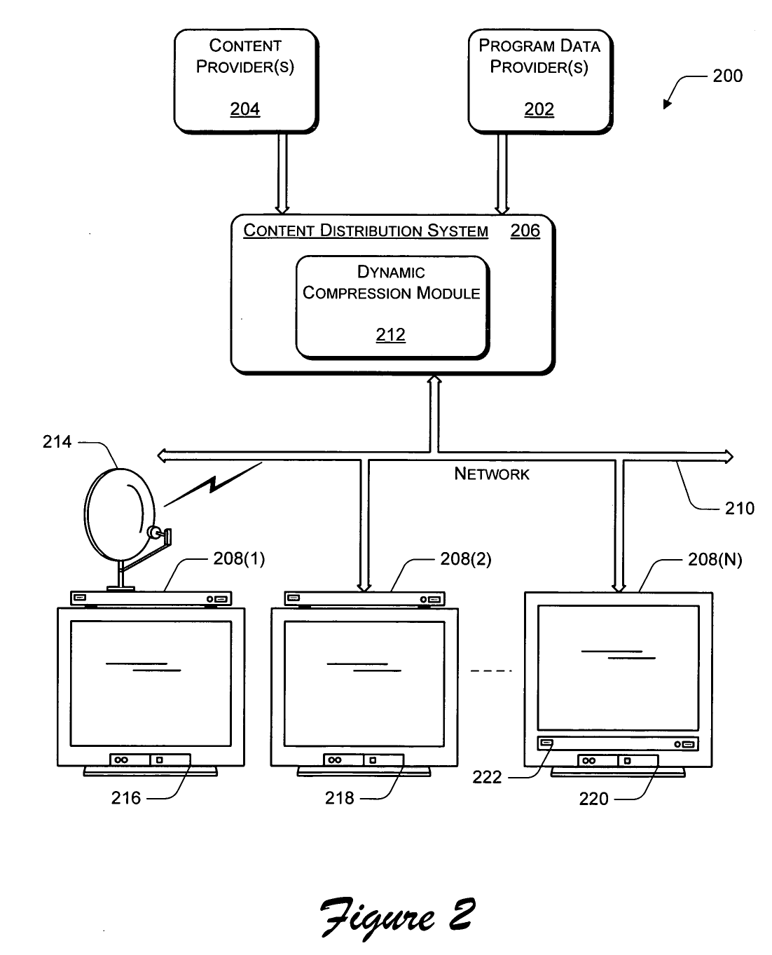

FIG. 2 illustrates an exemplary environment 200 in which dynamic data delivery may be implemented. Exemplary environment 200 is a television entertainment system that facilitates distribution of content and program data to multiple viewers. The environment 200 includes one or more program data providers 202, one or more content providers 204, a content distribution system 206, and multiple client devices 208(1), 208(2), . . . , 208(N) coupled to the content distribution system 206 via a network 210.

Program data providers 202 provide to content distribution system 206, data for populating an electronic program guide. Such data may include program identifiers, program titles, ratings, characters, descriptions, actor names, station identifiers, channel identifiers, schedule information, and so on. Content providers 204 provide to content distribution system 206, media content such as movies, television programs, commercials, music, and similar audio and/or video content.

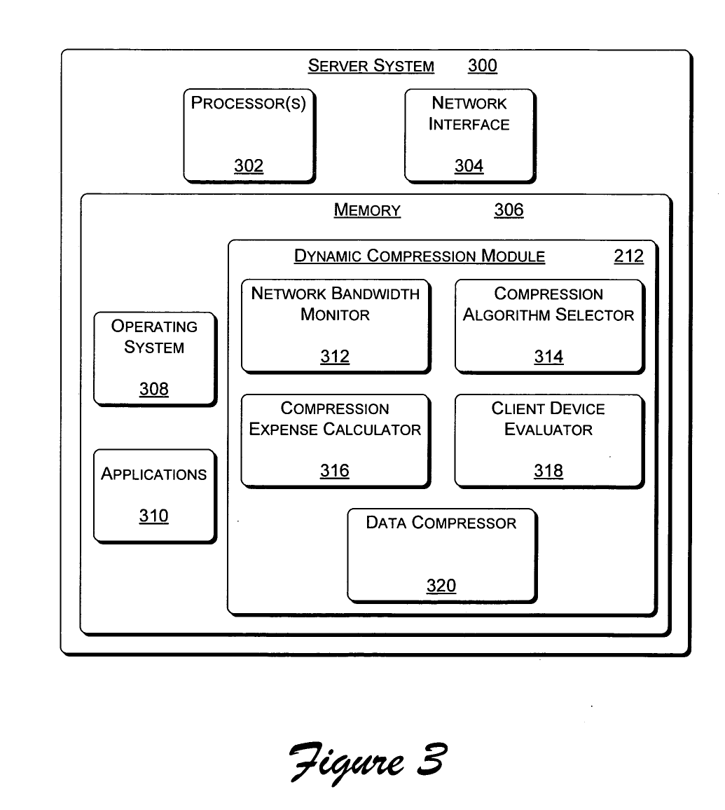

Content distribution system 206 is representative of a headend service that provides EPG data, as well as content, to multiple subscribers. Content distribution system 206 transmits the received program data and media content to the multiple client devices 208(1), 208(2), . . . , 208(N). In the described exemplary implementation, content distribution system 206 utilizes a dynamic compression module 212 to determine whether or not and to what degree data should be compressed before it is transmitted to one or more of the client devices. Select components of an exemplary content distribution system 206 are described in further detail below with reference to FIG. 3.

Network 210 can include an IP-based network, cable television network, RF, microwave, satellite, and/or data network, such as the Internet, and may also support wired or wireless media using any format and/or protocol, such as broadcast, unicast, or multicast. Additionally, network 210 can be any type of network, using any type of network topology and any network communication protocol, and can be represented or otherwise implemented as a combination of two or more networks.

Client devices 208 can be implemented in any number of ways. For example, a client device 208(1) receives content from a satellite-based transmitter via a satellite dish 214. Client device 208(1) is also referred to as a set-top box or a satellite receiving device. Client device 208(1) is coupled to a television 216 for presenting the content received by the client device (e.g., EPG data, audio data, and video data), as well as a graphical user interface. A particular client device 208 can be coupled to any number of televisions and/or similar devices that can be implemented to display or otherwise render content. Similarly, any number of client devices 208 can be coupled to a television. For example, a personal computer may be implemented as an additional client device capable of receiving EPG data and/or media content and communicating with a set-top box, television, or other type of display device.

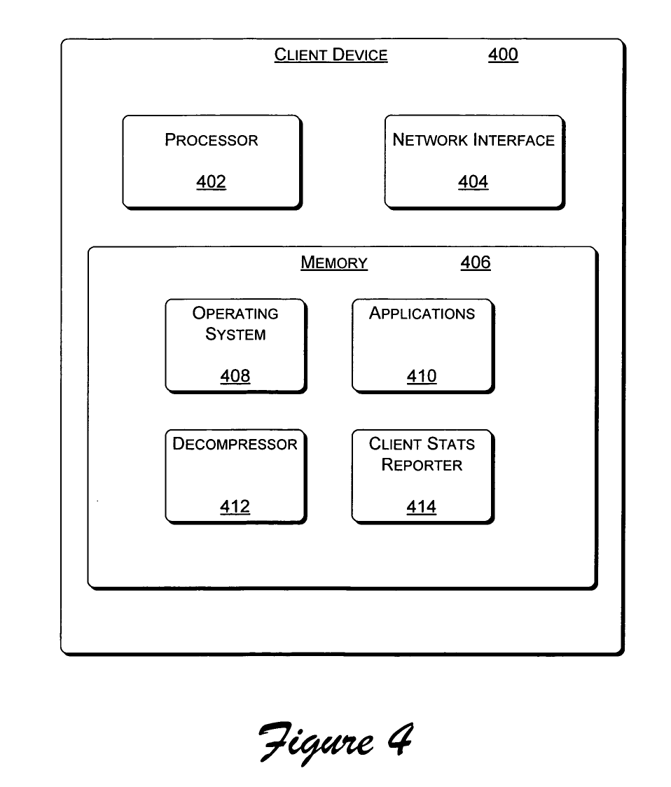

Client device 208(2) is also coupled to receive content from network 210 and provide the received content to associated television 218. Client device 208(N) is an example of a combination television 220 and integrated set-top box 222. In this example, the various components and functionality of the set-top box are incorporated into the television, rather than using two separate devices. The set-top box incorporated into the television may receive signals via a satellite dish (similar to satellite dish 214) and/or via network 210. In alternate implementations, client devices 208 may receive signals via the Internet or any other medium (e.g., broadcast, unicast, or multicast). Select components of an exemplary client device are described in further detail below with reference to FIG. 4.

FIG. 3 illustrates select components of an exemplary server system 300 configured to perform dynamic data delivery. Server system 300 includes one or more processors 302, network interface 304, and memory 306. Network interface 304 enables server system 300 to send and/or receive data over a network.

Operating system 308, applications 310, and dynamic compression module 212 are stored in memory 306 and executed on processor(s) 302. Application 310 may include, for example, an EPG application for preparing EPG data to be sent to a client device and a content preparation application for preparing media content to be sent to a client device.

Dynamic compression module 212 includes one or more of a network bandwidth monitor 312, a compression algorithm selector 314, a compression expense calculator 316, a client device evaluator 318, and a data compressor 320.

Network bandwidth monitor 312 is configured to monitor the overall available network bandwidth and/or to monitor the available network bandwidth between server system 300 and one or more specific client devices. Any number of well known techniques for monitoring available network bandwidth may be utilized by network bandwidth monitor 312, including, but not limited to, packet loss, as reflected by the number of requested packet retries, and transit time reporting, in which the time it takes for data to travel from the server to a client device is monitored, either by the server or by a client device.

Network bandwidth monitor 312 may also be configured to monitor variances in bandwidth cost over time. Network bandwidth monitor 312 may simply track the current bandwidth cost, or may track changes in bandwidth cost over time, which may then be used to predict changes in bandwidth cost, based on past changes in bandwidth cost.

Compression algorithm selector 314 is configured to select a particular compression algorithm to be applied to data before it is transmitted over the network. Compression algorithm selector 314 may be configured to utilize any number of techniques for selecting a particular compression algorithm to be applied. One factor that may be used for selecting a particular compression algorithm may be a degree of compression that can be achieved with the particular compression algorithm. For example, depending on the degree of network bandwidth restriction, varying degrees of data compression may be desired.

Another factor that may be used for selecting a particular compression algorithm may be knowledge of which algorithm works best for a particular data type. For example, a lossy compression algorithm may be selected for data that is resilient to loss, while a lossless compression algorithm may be selected for data that is not resilient to loss. Data loss resiliency may be determined, for example, based on a data type associated with the data to be compressed (e.g., SOAP and XML data is typically not resilient to loss while video and image data is typically resilient to loss).

Compression expense calculator 316 is configured to compare processing time associated with data in an uncompressed format and processing time associated with data in a compressed format. For example, processing time associated with data in an uncompressed format may be an expected time required to transmit the uncompressed data from the server to a client device. Processing time associated with data in a compressed format may be a sum of an expected time to compress the data, an expected time to transmit the compressed data, and an expected time to decompress the compressed data. In an exemplary implementation, the calculations are simplified by not including the expected processing time required to compress the data because it is assumed that the time required for the server to compress the data is negligible compared with the time required to transmit the data over the network and the time required for the client device to decompress the data.

Client device evaluator 318 is configured to evaluate characteristics associated with a client device to which data is to be transmitted. The evaluation may include, but is not limited to, determining a storage capacity available to the client device and/or determining a time at which the client device is expected to use the data that is to be transmitted.

Data compressor 320 is configured to automatically determine whether or not to compress data based on input from at least one of network bandwidth monitor 312, compression algorithm selector 314, compression expense calculator 316, and client device evaluator 318. Data compressor 320 may further be configured to automatically determine which of a plurality of compression algorithms to apply.

FIG. 4 illustrates select components of an exemplary client device configured to receive data that has been processed using dynamic data delivery techniques. Client device 400 includes processor 402, network interface 404, and memory 406. Network interface 404 enables client device 400 to send and/or receive data over a network.

Operating system 408, one or more applications 410, decompressor 412, and client statistics reporter 414 are stored in memory and executed on processor 402. Applications 410 may include, for example, an EPG application for rendering an electronic program guide. Decompressor 412 is configured to decompress received data that has been compressed as a result of dynamic data delivery. Client statistics reporter 414 is configured to determine and/or maintain dynamic and/or static statistics associated with client device 400, and report those statistics to a server. Client processor speed is one example of a static value that may be maintained and reported by client statistics reporter 414. Client statistics reporter 414 may also determine and report dynamic statistics, which may include, but are not limited to, current available storage, current available memory, and current CPU load.

Methods for dynamic data delivery may be described in the general context of computer executable instructions. Generally, computer executable instructions include routines, programs, objects, components, data structures, procedures, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

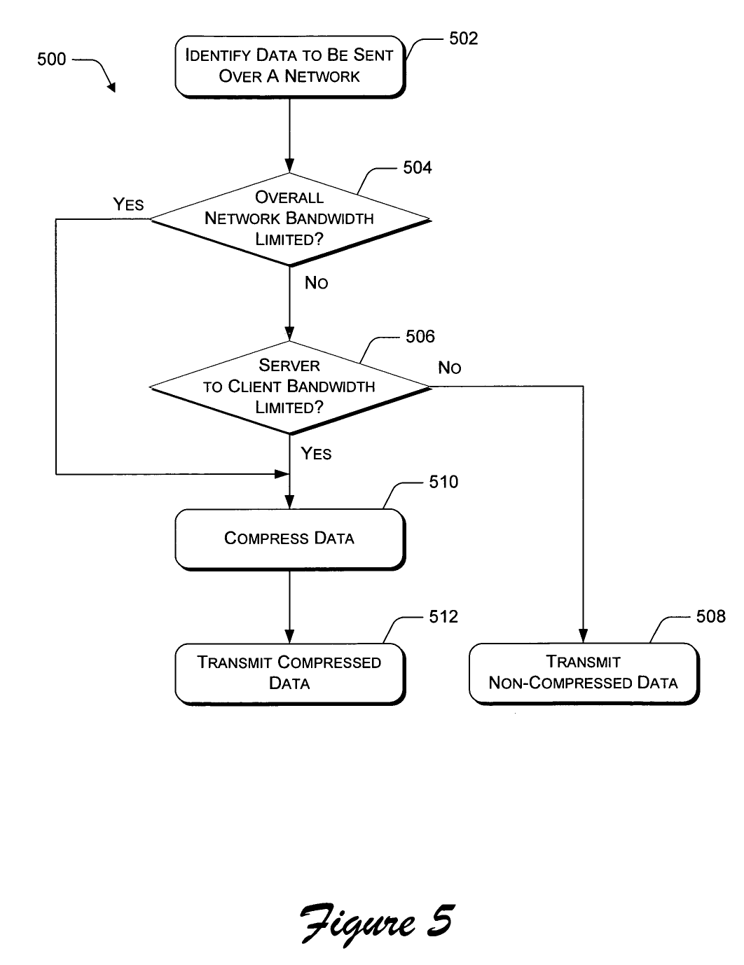

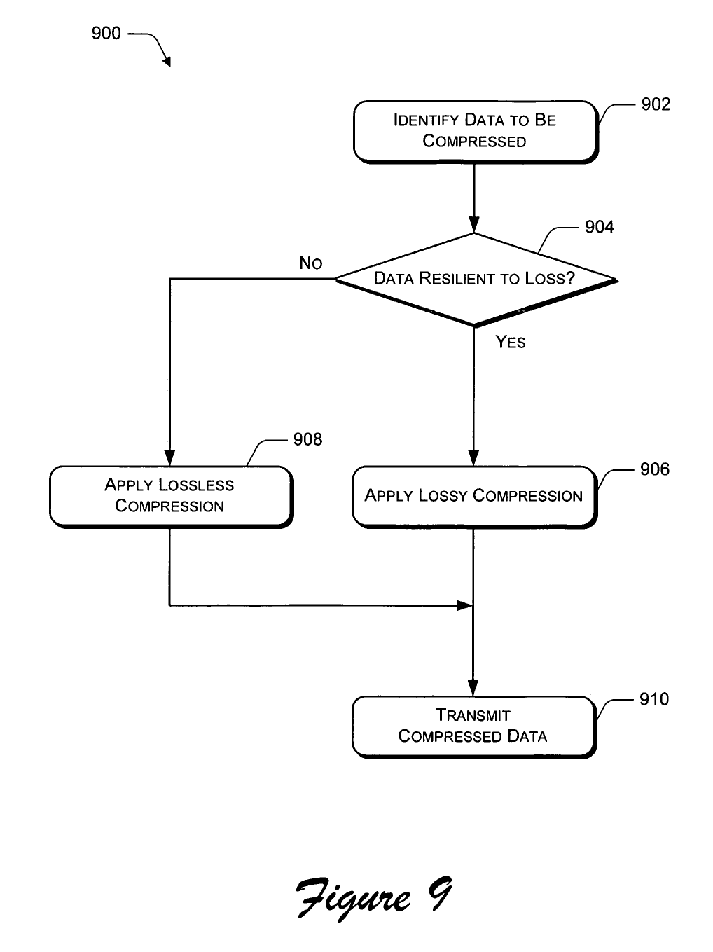

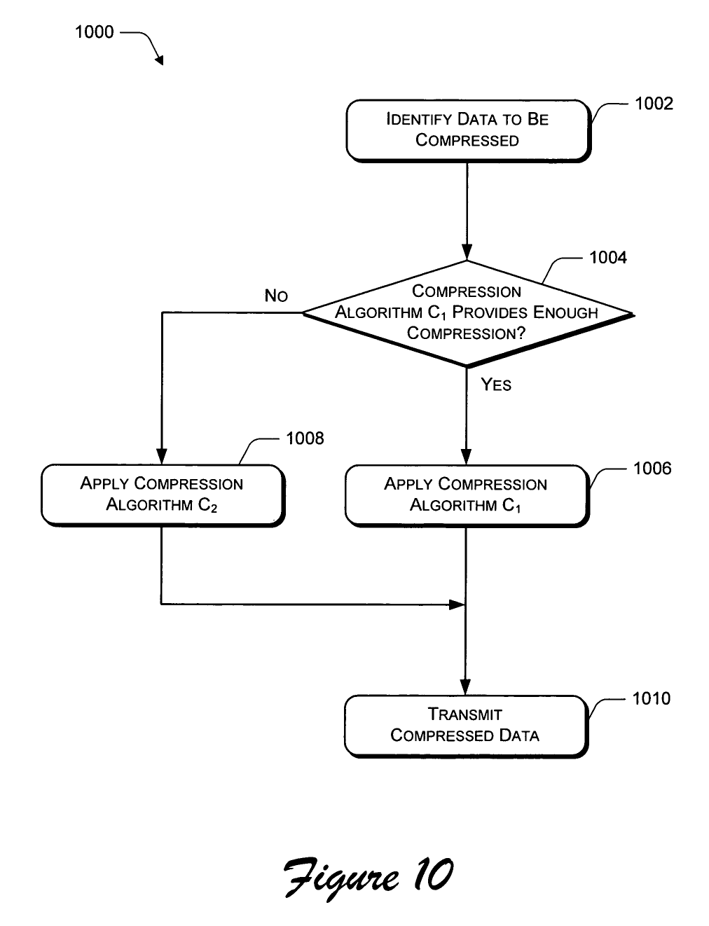

FIGS. 5-8 illustrate exemplary methods for determining whether or not to compress data that is to be transmitted over a network and/or for determining when to transmit data over a network. FIGS. 9-10 illustrate exemplary methods for determining how to compress data that is to be transmitted over a network. The methods illustrated in FIGS. 5-10 are specific examples of dynamic data delivery, and are not to be construed as limitations. Furthermore, it is recognized that various embodiments may implement any combination of the methods illustrated in FIGS. 5-10 or any combination of portions of the methods illustrated in FIGS. 5-10.

FIG. 5 illustrates an exemplary method 500 for an embodiment of dynamic data delivery based on network bandwidth availability. The order in which the method is described is not intended to be construed as a limitation, and any number of the described method blocks can be combined in any order to implement the method. Furthermore, the method can be implemented in any suitable hardware, software, firmware, or combination thereof.

At block 502, a server identifies data to be sent over a network. For example, a server may receive a request for a particular file from a specific client device.

At block 504, the server determines whether or not the overall network bandwidth is currently limited. Network bandwidth may be limited for various reasons. For example, in a television entertainment system, the network over which media content is delivered may have limited bandwidth during prime time, when more viewers are requesting content from the server. Many well-known techniques exist for determining current network throughput, including, but not limited to, packet loss and transit time reporting. Packet loss, as reflected by a requested number of packet retries is one reliable predictor of network bandwidth limitations. In one implementation of transit time reporting, a client device reports back to the server a time at which data is received. The server can then calculate how long it took for the data to be transmitted over the network. In an alternate implementation of transit time reporting, the server affixes a timestamp to the data that is sent. The client then compares the timestamp to the time at which the data was received to determine how long it took for the data to be transmitted over the network. In this implementation, the client can then determine whether or not to request compressed data, based on the network bandwidth constraints.

If it is determined that the overall network bandwidth is limited (the “Yes” branch from block 504), then processing continues at block 510, as described below. On the other hand, if it is determined that the overall network bandwidth is not limited (the “No” branch from block 504), then at block 506, the server determines whether or not the network bandwidth is limited between the server and the requesting client. For example, a bottleneck somewhere in the network between the server and the requesting client may cause bandwidth limitations for data being sent to that particular client, but may not cause overall network bandwidth limitations. As described above, well-known techniques may be use to determine the existence of bandwidth limitations.

If it is determined that no bandwidth limitations exist (the “No” branch from block 506), then at block 508, the server transmits the data without first compressing the data. On the other hand, if it is determined that there are bandwidth limitations (either overall network bandwidth limitations as determined at block 504 or client-specific network bandwidth limitations as determined at block 506), then at block 510, the server compresses the data to be transmitted. FIGS. 9 and 10, described below, illustrate two exemplary ways in which the data may be compressed. At block 512, the server transmits the compressed data over the network.

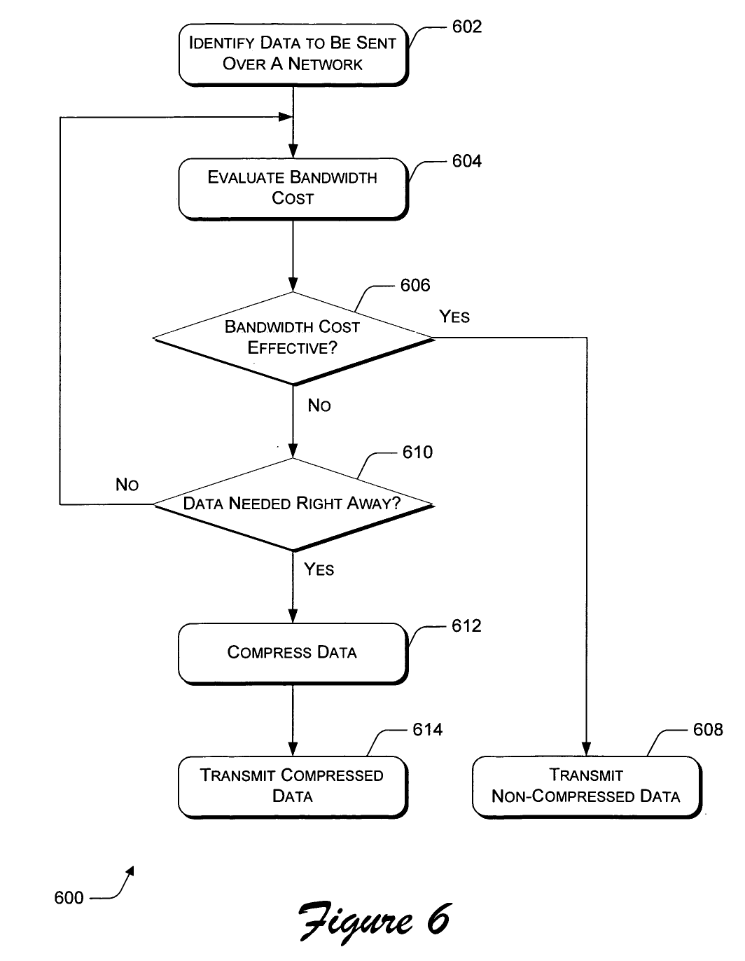

FIG. 6 illustrates an exemplary method 600 for an embodiment of dynamic data delivery based on network bandwidth cost. The order in which the method is described is not intended to be construed as a limitation, and any number of the described method blocks can be combined in any order to implement the method. Furthermore, the method can be implemented in any suitable hardware, software, firmware, or combination thereof.

In an exemplary implementation, a server may evaluate bandwidth cost to determine whether or not to send requested data immediately, and/or whether or not to compress the data before it is sent. FIG. 6 illustrates an exemplary implementation in which data is transmitted in an uncompressed format if bandwidth is cost effective, or the server waits until bandwidth becomes cost effective before sending the data, or the server compresses and transmits the data when the bandwidth is not cost effective. In an alternate implementation, the server may also determine whether to compress and send the data right away or to wait based on a prediction of whether or not bandwidth cost is expected to drop soon, based, for example, on past statistics.

At block 602, a server identifies data to be sent over a network. For example, a server may receive a request for a particular file from a specific client device.

At block 604, the server evaluates the current bandwidth cost. For example, an operator of the server (e.g., a subscription television company) may be charged monetarily for bandwidth use. Furthermore, the bandwidth cost may vary over time. For example, during peak hours (e.g., prime time), bandwidth may be more expensive than during off-peak hours.

At block 606, the server determines whether sending the requested data at the current time is cost effective. If it is determined that sending the data at the current time is cost effective (the “Yes” branch from block 606), then at block 608, the server transmits the requested data in a non-compressed format.

On the other hand, if the server determines that sending the requested data at the current time is not cost effective (the “No” branch from block 606), then at block 610, the server determines whether the client needs the requested data right away. For example, a received request for the data may indicate a date and/or time at which the data is expected to be viewed. Alternatively, if the requested data is a movie, and the data can be transmitted faster than the data can be viewed, then a first portion of the movie may be transmitted right away, and a later portion of the movie may be transmitted at a later time, when bandwidth may be less expensive. If it is determined that the data is not needed right away, then processing continues as described above with reference to block 604, and the data is transmitted as described with reference to block 608, when the bandwidth becomes cost effective, or the data is transmitted as described below with reference to block 612 and 614 when it is determined that the data is needed right away.

If bandwidth is not cost effective and it is determined that the data is needed right away (the “Yes” branch from block 610), then at block 612, the server compresses the data to be transmitted.

At block 614, the server transmits the compressed data over the network to the client device.

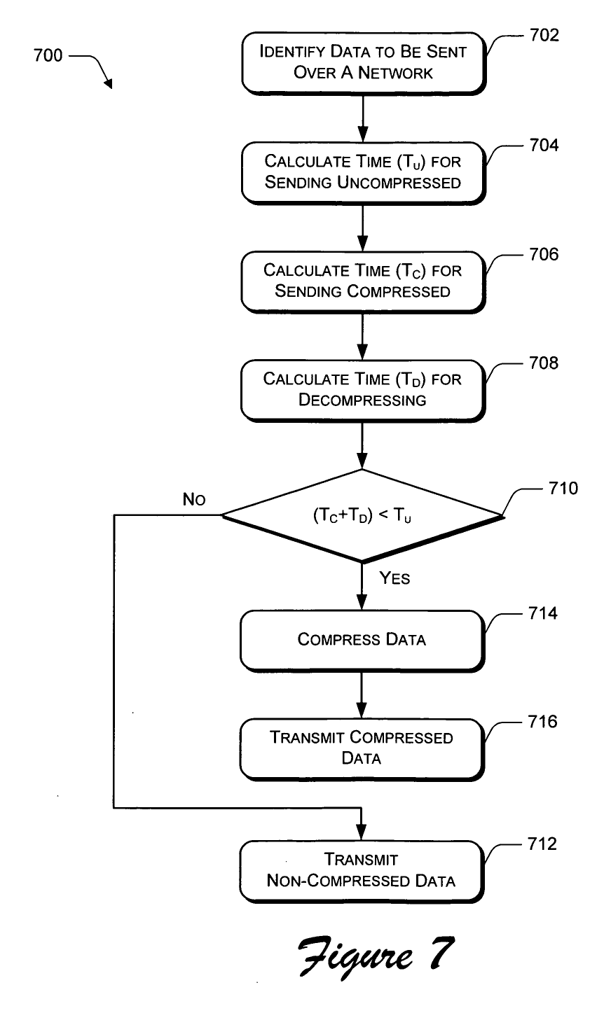

FIG. 7 illustrates an exemplary method 700 for an embodiment of dynamic data delivery based on expected processing time. The order in which the method is described is not intended to be construed as a limitation, and any number of the described method blocks can be combined in any order to implement the method. Furthermore, the method can be implemented in any suitable hardware, software, firmware, or combination thereof.

At block 702, a server identifies data to be sent over a network.

At block 704, the server calculates the time (T_{U}) it is expected to take to send the data over the network in an uncompressed format.

At block 706, the server calculates the time (T_{C}) it is expected to take to send the data over the network in a compressed format.

At block 708, the server calculates the time (T_{D}) it is expected to take for the client device to decompress the data sent in the compressed format.

At block 710, the server determines whether or not (T_{C}+T_{D})<T_{U}. The server determines if it will take longer to transmit the data in an uncompressed format or if it will take longer to transmit the data in a compressed format and then have the client device decompress the data. If it would take longer to transmit and decompress the compressed data (i.e., (T_{C}+T_{D})>T_{U}) (the “No” branch from block 710), then at block 712, the server transmits the data over the network in an uncompressed format.

On the other hand, if it is determined that (T_{C}+T_{D})<T_{U} (the “Yes” branch from block 710), then at block 714, the server applies a compression scheme to the data. FIGS. 9 and 10, described below, illustrate two exemplary ways in which the data may be compressed. At block 716, the server transmits the compressed data over the network.

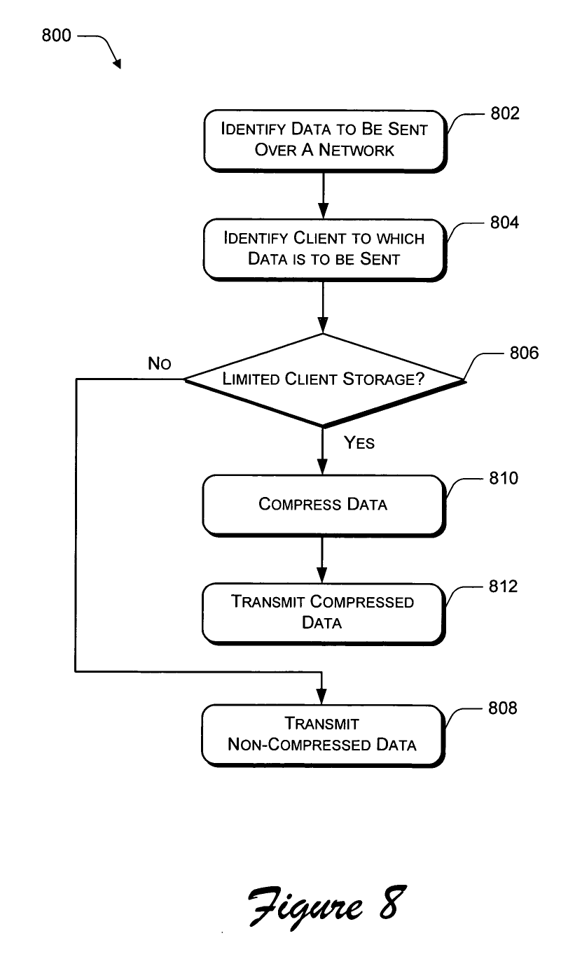

FIG. 8 illustrates an exemplary method 800 for an embodiment of dynamic data delivery based on client storage capabilities. The order in which the method is described is not intended to be construed as a limitation, and any number of the described method blocks can be combined in any order to implement the method. Furthermore, the method can be implemented in any suitable hardware, software, firmware, or combination thereof.

At block 802, a server identifies data to be sent over a network.

At block 804, the server identifies a client device to which the data is to be sent. For example, a data request may have been received that includes a client device identifier.

At block 806, the server determines whether or not the requesting client device has limited storage capabilities. For example, the server may examine known client device characteristics to determine the storage capabilities of the requesting client device.

If it is determined that the client device storage capabilities are sufficient (the “No” branch from block 806), then at block 808, the server transmits the requested data in an uncompressed format.

On the other hand, if it is determined that the client device storage capabilities are restricted (the “Yes” branch from block 806), then at block 810, the server applies a compression algorithm to the data. FIGS. 9 and 10, described below, illustrate two exemplary ways in which the data may be compressed. At block 812, the server transmits the compressed data over the network to the client device.

FIG. 9 illustrates an exemplary method 900 for an embodiment of dynamic data delivery based on the type of data to be transmitted. The order in which the method is described is not intended to be construed as a limitation, and any number of the described method blocks can be combined in any order to implement the method. Furthermore, the method can be implemented in any suitable hardware, software, firmware, or combination thereof.

At block 902, the server identifies data to be compressed and transmitted over a network. For example, method 900 may be implemented as part of block 510 shown in FIG. 5, as part of block 714 shown in FIG. 7, or as part of block 810 shown in FIG. 8.

At block 904, the server determines whether or not the identified data is resilient to loss. For example, data such as extensible markup language (XML), human readable text, and simple object access protocol (SOAP) files should generally be transmitted completely accurately in order to be used properly, and so, are not resilient to loss. On the other hand, data such as images, music files, and video streams are typically resilient to loss of some non-critical data.

If it is determined that the identified data is resilient to loss (the “Yes” branch from block 904), then at block 906, the server applies a lossy compression algorithm. On the other hand, if it is determined that the identified data is not resilient to loss (the “No” branch from block 904), then at block 908, the server applies a lossless compression algorithm.

At block 910, the server transmits the compressed data over the network.

FIG. 9 illustrates an implementation in which only two compression algorithms are available, namely, a lossless compression algorithm and a lossy compression algorithm. In an alternate implementation, additional compression algorithms may also be considered. For example, lossy compression algorithms may be appropriate for both voice and photo data, but greater compression may be applied to the photo data than to the voice data before significant data degradation is experienced. In such an example, after it is determined that a lossy compression algorithm will be used, further evaluation may be performed to determine which of multiple lossy compression algorithms to use.

FIG. 10 illustrates an exemplary method 1000 for an embodiment of dynamic data delivery based on degree of compression. The order in which the method is described is not intended to be construed as a limitation, and any number of the described method blocks can be combined in any order to implement the method. Furthermore, the method can be implemented in any suitable hardware, software, firmware, or combination thereof.

At block 1002, the server identifies data to be compressed and transmitted over a network. For example, method 1000 may be implemented as part of block 510 shown in FIG. 5, as part of block 714 shown in FIG. 7, or as part of block 810 shown in FIG. 8. In the illustrated example, the server is configured to apply one of two compression algorithms C₁ and C₂, where C₂ results in greater compression than C₁.

At block 1004, the server determines whether or not compression algorithm C₁ will result in sufficient compression. For example, if the compression is to be performed based on network bandwidth limitations, then the server determines whether or not the result of compression algorithm C₁ will be sufficiently compressed to overcome the bandwidth limitations.

If it is determined that compression algorithm C₁ will result in sufficient compression (the “Yes” branch from block 1004), then at block 1006, compression algorithm C₁ is applied to the identified data. On the other hand, if it is determined that compression algorithm C₁ will not result in sufficient compression (the “No” branch from block 1004), then at block 1008, the server applies compression algorithm C₂ to the identified data.

At block 1010, the compressed data is transmitted over the network.

FIG. 10 illustrates an implementation in which only two compression algorithms are available. In an alternate implementation, additional compression algorithms may also be considered.

Although embodiments of dynamic data delivery have been described in language specific to structural features and/or methods, it is to be understood that the subject of the appended claims is not necessarily limited to the specific features or methods described. Rather, the specific features and methods are disclosed as exemplary implementations of dynamic data delivery.

1. A method, comprising:
determining available bandwidth for transmitting data over a network; and
in an event that the available bandwidth is greater than a particular threshold value, transmitting the data over the network; and
in an event that the available bandwidth is below a particular threshold value:
generating compressed data by compressing the data; and
transmitting the compressed data over the network.

2. The method as recited in claim 1, further comprising:
in an event that the available bandwidth is greater than a particular threshold value:
evaluating a current network cost;
in an event that the current network cost is acceptable, transmitting the data over the network; and
in an event that the current network cost is unacceptable:
determining whether the data can be sent at a later time;
in an event that the data can be sent at a later time, transmitting the data over the network at a later time at which the network cost is acceptable; and
in an event that the data cannot be sent at a later time:
generating compressed data by compressing the data; and
transmitting the compressed data over the network.

3. The method as recited in claim 1, wherein the available bandwidth comprises a client-specific bandwidth available between a server and a particular client device, wherein the client-specific bandwidth may be less than an overall network bandwidth available to the server.

4. The method as recited in claim 1, wherein the generating compressed data comprises:
determining whether the data is resilient to loss;
in an event that the data is resilient to loss, applying a lossy compression algorithm to the data; and
in an event that the data is not resilient to loss, applying a lossless compression algorithm to the data.

5. The method as recited in claim 1, wherein the generating compressed data comprises:
determining a compressed data size that will result from applying a first compression algorithm to the data to be transmitted over the network;
in an event that the compressed data size is sufficiently reduced compared to an uncompressed data size associated with the data to be transmitted over the network, applying the first compression algorithm to the data to be transmitted over the network; and
in an event that the compressed data size is not sufficiently reduced compared to an uncompressed data size associated with the data to be transmitted over the network, applying a second compression algorithm to the data to be transmitted over the network, where the second compression algorithm provides greater compression than the first compression algorithm.

6. The method as recited in claim 1, further comprising:
determining a duration of time (T_{U}) expected to transmit the data over the network;
determining a duration of time (T_{C}) expected to transmit the compressed data over the network;
determining a duration of time (T_{D}) expected for a client device to decompress the compressed data;
in an event that (T_{C}+T_{D})>T_{U}, transmitting the data over the network; and
in an event that (T_{C}+T_{D})<T_{U}:
generating compressed data by compressing the data to be transmitted over the network; and
transmitting the compressed data over the network.

7. The method as recited in claim 1, further comprising:
identifying a client device to which the data is to be transmitted;
determining a storage capacity associated with the client device;
in an event that the storage capacity is greater than a particular threshold value, transmitting the data over the network to the client device; and
in an event that the storage capacity is less than a particular threshold value:
generating compressed data by compressing the data to be transmitted over the network; and
transmitting the compressed data over the network to the client device.

8. A dynamic data compression module, comprising:
a compression expense calculator configured to compare an expected transmission time (T_{U}) for data to be transmitted over a network in an uncompressed format to a sum (T_{C}+T_{D}) of an expected transmission time (T_{C}) for the data to be transmitted over the network in a compressed format and an expected decompression time (T_{D}) for a client device to decompress the data from the compressed format; and
a data compressor configured to dynamically apply the compression algorithm to the data to be transmitted over the network if (T_{C}+T_{D})<(T_{U}).

9. The system as recited in claim 8, further comprising a compression algorithm selector configured to automatically select the compression algorithm from a plurality of compression algorithms.

10. The system as recited in claim 8, further comprising a compression algorithm selector configured to automatically select the compression algorithm from a plurality of compression algorithms based on a resiliency to loss associated with the data to be transmitted over the network.

11. The system as recited in claim 10, wherein the resiliency to loss is based on a data type associated with the data to be transmitted over the network.

12. The system as recited in claim 8, further comprising a compression algorithm selector configured to automatically select the compression algorithm from a plurality of compression algorithms based on an expected rate of compression associated with each of the plurality of compression algorithms.

13. The system as recited in claim 8, further comprising a network bandwidth monitor configured to determine bandwidth available on a network, wherein the data compressor is further configured to dynamically apply a compression algorithm to the data to be transmitted over the network based on the bandwidth available on the network.

14. The system as recited in claim 8, further comprising a client device storage capacity evaluator configured to evaluate a storage capacity associated with a client device to which the data is to be transmitted, wherein the data compressor is further configured to dynamically apply a compression algorithm to the data to be transmitted over the network based on the storage capacity associated with the client device.

15. One or more computer-readable media comprising computer-executable instructions that, when executed, direct a computing system to:
determine a resiliency to loss associated with data to be sent over a network;
in an event that the data is resilient to loss, automatically apply a lossy compression algorithm to the data; and
in an event that the data is not resilient to loss, automatically apply a lossless compression algorithm to the data.

16. The one or more computer-readable media as recited in claim 15, further comprising computer-executable instructions that, when executed, direct the computer system to:
determine available bandwidth associated with the network;
in an event that the available bandwidth is sufficient, transmit the data in an uncompressed format; and
in an event that the available bandwidth is sufficiently restricted, transmit the data in a compressed format.

17. The one or more computer-readable media as recited in claim 16, wherein the available bandwidth comprises available bandwidth between a server from which the data is to be transmitted and a client device to which the data is to be transmitted.

18. The one or more computer-readable media as recited in claim 15, further comprising computer-executable instructions that, when executed, direct the computer system to:
determine an expected duration (T_{U}) for transmitting the data over the network in an uncompressed format;
determine a sum (T_{C}+T_{D}) of an expected duration for transmitting the data over the network in a compressed format (T_{C}) and an expected duration for decompressing the data (T_{D});
in an event that (T_{U})<(T_{C}+T_{D}), transmitting the data over the network in an uncompressed format; and
in an event that (T_{C}+T_{D})<(T_{U}), transmitting the data over the network in the compressed format.

19. The one or more computer-readable media as recited in claim 15, further comprising computer-executable instructions that, when executed, direct the computer system to:
examine characteristics associated with a client device to which the data is to be transmitted; and
automatically determine a compressed or uncompressed format in which the data will be transmitted based on the characteristics associated with the client device.

20. The one or more computer-readable media as recited in claim 19, wherein the characteristics associated with the client device comprise at least one of a data storage capacity or an expected usage time for the data.
